(19) United States
(12) Patent Application Publication
(10) Pub. No.: US 2008/0172271 A1
(43) Pub. Date: Jul. 17, 2008

(54) METHOD AND APPARATUS FOR MONITORING INVALID CLICKS

(75) Inventors: Wu Sic Wee, Gyeonggi-do (KR); Min Uk Kim, Seoul (KR); Kyung Sun Ko, Seoul (KR)

Correspondence Address: HUSCH BLACKWELL SANDERS LLP, 720 OLIVE STREET, SUITE 2400, ST. LOUIS, MO, 63101, US

(73) Assignee: NHN CORPORATION, Kyunggi-do (KR)

(21) Appl. No.: 12/014,196

(22) Filed: Jan. 15, 2008

(30) Foreign Application Priority Data
Jan. 16, 2007 (KR) 10-2007-0004838

(51) Int. Cl. G06F 17/00

(52) U.S. Cl. 705/7

(57) ABSTRACT

A charging method of an Internet advertisement is provided. A method of monitoring an invalid click on a search advertisement, the method including: tracking user's activities after clicking a web site which is displayed as online advertisement, based, at least in part, upon predetermined rules; collecting the tracking information of the user's activities; analyzing at least one activity pattern of the user's activities based, at least in part, upon the collected tracking information; and determining if the user's click is an invalid click based, at least in part, upon the analyzed activity pattern and a predetermined reference value.

### CROSS-REFERENCE TO RELATED APPLICATION

This application claims the benefit of Korean Patent Application No. 10-2007-0004838, filed on Jan. 16, 2007, in the Korean Intellectual Property Office, the disclosure of which is incorporated herein by reference.

### BACKGROUND OF THE INVENTION

1. Field of the Invention

The present invention relates to a charging method of an Internet advertisement, and more particularly, to a method and apparatus for effectively monitoring an invalid click in association with charging of an Internet advertisement.

2. Description of Related Art

Due to astonishing developments in advertisements in the Internet, Internet advertisements using search sites are common. Operators of the search sites make profits by displaying advertisements of advertisers who desire to advertise their websites for Internet users who visit the search sites, and charging the advertisers.

A representative charging scheme of an Internet advertisement is a cost per click (hereinafter, referred to as “CPC”) scheme that was suggested by Overture company. The CPC scheme denotes a charging scheme in which an advertiser pays a predetermined advertisement fee every time an Internet user clicks an advertisement link of a search site that displays advertisements for Internet users. The CPC scheme is generally used in a keyword advertisement of a search engine. When the Internet user clicks a link of an advertiser that is displayed on a search result page of the search site, the advertiser pays a predetermined advertisement fee.

However, in the CPC scheme, even though the Internet user repeats clicks with a malicious intent and the clicks are unassociated with the actual purchase, the advertiser may have to pay an unreasonable advertisement fee for such invalid clicks. The invalid click or fraudulent click is generally referred to activities which occur in pay per click online advertising when a person, automated script, or computer program imitate a legitimate user of a web browser clicking on an ad, for the purpose of generating a charge per click without having actual interest in the target of the ad's link. In some cases, an Internet user with a malicious intent may cause unreasonable charging by fraudulently clicking an advertisement of a competing company. This is completely opposite to expectation of an advertiser that a click on a website of the advertiser will be connected to the actual purchase. Accordingly, legal arguments and compensations regarding invalid clicks are being made between advertisers and search sites such as Google, Overture, and the like.

To solve the above problems regarding invalid clicks, DAUM communications disclosed in the Korean Patent Laid-Open Publication No. 2006-103035, a charging method of an Internet advertisement which can issue a first cookie to a user terminal, receive advertisement click information, set the first cookie to not process a charge when the issued date of the first cookie does not elapse from a predetermined period of time based on the received advertisement click information, and, conversely, issue a second cookie to the user terminal when the issued date elapses from the predetermined period of time based on the received advertisement click information. In this instance, the first cookie stores the issued date and an identifier in association with the Internet user's access to a website that displays an advertisement. The second cookie is set to charge only once for a duplicate click within a predetermined session time.

Million Communications Co. Ltd. disclosed in the Korean Patent Laid-Open Publication No. 2006-112849, a method which can store in a cookie a number of accesses using an Internet Protocol (IP) address that is allocated to a user computer and send a text message to an operator of a customer web server when the number of accesses is greater than a predetermined reference value.

However, the conventional methods identify invalid clicks based on a time interval between clicks or based on a number of accesses from the same IP address. Specifically, the conventional methods simply determine invalid clicks based on only one criterion. On the side of advertisers, the invalid clicks include various types of clicks that are not connected to the actual purchase. Specifically, the conventional methods may determine invalid clicks based on only one simple criterion and thus may not appropriately cope with various types of intelligently developing invalid clicks of users.

### BRIEF SUMMARY OF THE INVENTION

An aspect of the present invention provides a method and apparatus for classifying clicks with the purchase intent based on various types of user actions and thereby effectively monitoring an invalid click.

According to an aspect of the present invention, there is provided a method of monitoring an invalid click on a search advertisement, the method including: tracking user's activities after clicking a web site which is displayed as online advertisement, based, at least in part, upon predetermined rules; collecting the tracking information of the user's activities; analyzing at least one activity pattern of the user's activities based, at least in part, upon the collected tracking information; and determining if the user's click is an invalid click based, at least in part, upon the analyzed activity pattern and a predetermined reference value.

In an aspect of the present invention, the average activity pattern is analyzed in accordance with predetermined pattern rules.

If the user's click is determined as invalid click, the service provider would not charge for the invalid click for the purpose of the pay per click online advertising.

Also, the collected tracking information may include at least one of a login flag, a previously visited Universal Resource Locator (URL), a user identifier (ID), a window ID, a focus/unfocus/open/close event of a particular window, a currently visited URL, and a date and time when a click on a particular menu occurs.

Also, the collected tracking information may further include at least one of a country of an accessed user and Greenwich Mean Time (GMT).

According to another aspect of the present invention, there is provided a system for monitoring activity associated with a web site, the system comprising: a tracking information collection module configured to collect tracking information of user's activities after clicking a web site which is displayed as online advertisement, based, at least in part, upon predetermined rules; a user action pattern analysis module configured to analyze at least one activity pattern of the user's activities based, at least in part, upon aid collected tracking information; and an invalid click determination module configured to determine if the user's click is an invalid click based, at least in part, upon the analyzed activity pattern and a predetermined reference value.

Also, the invalid click monitoring server may connect to a charge server that excludes the action performed by the user from a charge, when the action performed by the user is determined as the invalid click.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a diagram illustrating a configuration of a system for monitoring an invalid click according to an exemplary embodiment of the present invention;

FIG. 2 is a diagram illustrating a configuration of an invalid click monitoring server according to an exemplary embodiment of the present invention; and

FIG. 3 is a flowchart illustrating a method of monitoring an invalid click according to an exemplary embodiment of the present invention.

It should be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted. It should be understood, of course, that the invention is not necessarily limited to the particular embodiments illustrated herein. Like numbers utilized throughout the various Figures designate like or similar parts or structure.

### DETAILED DESCRIPTION OF THE INVENTION

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

When detailed descriptions related to a well-known related function or configuration are determined to make the spirits of the present invention ambiguous, the detailed descriptions will be omitted herein. Also, terms used throughout the present specification are used to appropriately describe exemplary embodiments of the present invention, and thus may be different depending upon a user and an operator's intention, or practices of application fields of the present invention. Therefore, the terms must be defined based on descriptions made through the present invention

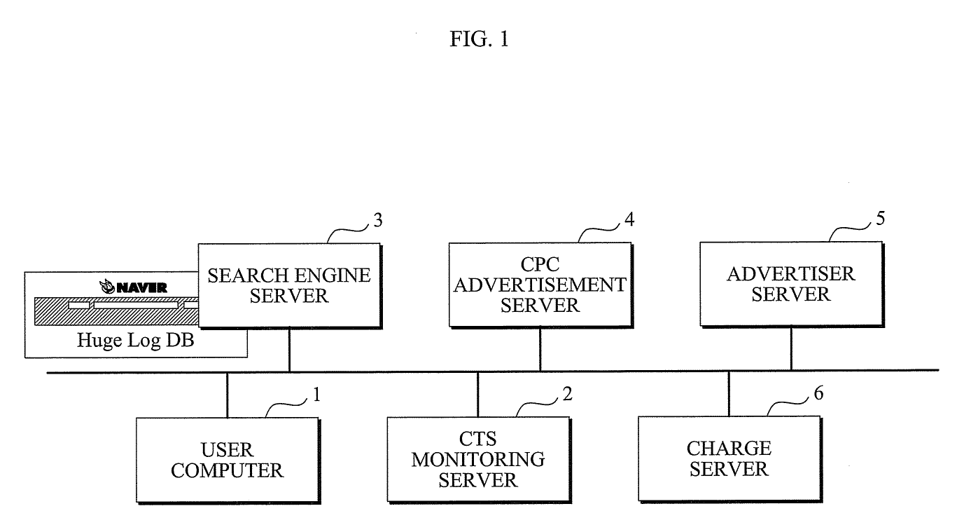

FIG. 1 is a diagram illustrating a configuration of a system for monitoring an invalid click according to an exemplary embodiment of the present invention.

Referring to FIG. 1, the invalid click monitoring system includes a user computer 1, a conversion tracking system (CTS) monitoring server 2, a search engine server 3, a cost per click (CPC) advertisement server 4, an advertiser server 5, and a charge server 6.

The user computer 1 denotes a computer that an Internet user performs desired searching using a search site and accesses the advertiser server 5 by clicking a CPC advertisement included in the search result. The search site is provided from the search engine server 3.

The search engine server 3 displays a search window so that the Internet user may more quickly access the desired website, and also displays a list of websites associated with a search keyword entered by the Internet user. Examples of the search engine server 3 may include servers that provide a CPC advertisement service on search sites such as Naver, Daum, Google, and the like.

The CPC advertisement server 4 provides the CPC advertisement in response to a request from an advertiser. Generally, a search site providing search services provides a CPC advertisement service.

The advertisement server 4 denotes a web server that provides a web service using the Internet. The website of the advertiser server 5 is linked to a search result list and displayed for the Internet user.

Specifically, when the Internet user enters a search word using the search engine of a search site such as Naver, Google, and the like, the search engine server 3 displays a related search result list for the Internet user. The search result list includes link information about CPC advertisement sites that are registered to the CPC advertisement server 4 and are also associated with the search word. When the Internet user clicks a link to a desired CPC advertisement site, the advertiser server 5 provides a website for the Internet user.

The CTS monitoring server 2 collects various types of actions a user performs after the user computer 1 accesses the website of the advertiser using the advertiser server 5, analyzes the collected actions, and determines whether the actions are invalid clicks. The CTS denotes a conversion tracking system. The CTS monitoring server 2 denotes a server that tracks a change followed by a user action and thereby effectively monitors an invalid click. Hereinafter, the CTS monitoring server 2 is referred to as “invalid click monitoring server 2”.

When the invalid click monitoring server 2 determines a user's particular action as an invalid click, the charge server 6 excludes the invalid click from charge.

Servers having respective functions may be constructed as separate servers or a separate server group depending on the intent of a system designer. Also, the servers may be constructed into a smaller number of servers by integrating functions.

Hereinafter, a method and apparatus for effectively monitoring an invalid click according to an exemplary embodiment of the present invention will be described in detail.

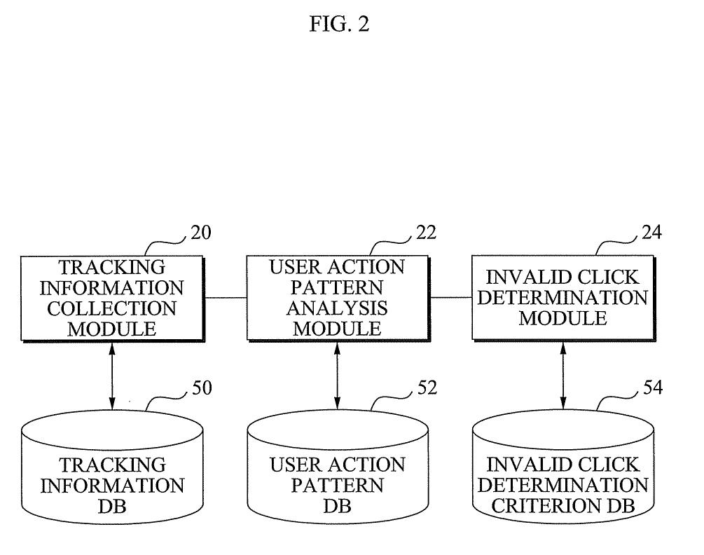

FIG. 2 is a diagram illustrating a configuration of an invalid click monitoring server according to an exemplary embodiment of the present invention.

Referring to FIG. 2, the invalid click monitoring server 2 includes a tracking information collection module 20, a user action pattern analysis module 22, and an invalid click determination module 24.

The tracking information collection module 20 collects tracking information. The tracking information signifies an action a user performs on a website of an advertiser after the user clicks the search advertisement and moves to the website.

The user action pattern analysis module 22 analyzes an average action pattern of the user based on the collected tracking information.

The invalid click determination module 24 determines the action performed by the user as the invalid click when the action performed by the user is outside of a predetermined reference value.

When the action performed by the user is determined as the invalid click, the invalid click monitoring server 2 may be connected to the charge server 6 that excludes the action performed by the user from a charge.

The user may perform various types of actions after clicking the search advertisement using the advertiser server 5. Specifically, the user may perform various types of actions associated with the actual purchase, such as clicking a menu of an advertiser site, accessing a linked site, clicking a menu associated with an actual purchase, attempting to log into a site to make a purchase, and the like. Conversely, the user may perform actions unassociated with the actual purchase, such as closing an advertisement site window, ignoring the advertisement site without click on it, copying only a telephone number of an advertiser for advertiser information in the case of an agency, and the like.

According to the present invention, there is provided an effective invalid click monitoring server that can track a user's various types of action patterns after clicking a search advertisement and determine whether the user has a purchase intent based on the tracked action patterns.

Specifically, the invalid click monitoring server according to the present exemplary embodiment collects, using the tracking information collection module 20, tracking information about various types of actions performed by a user after clicking the search advertisement and stores the collected tracking information in a tracking information database 50. The invalid click monitoring server analyzes, using the user action pattern analysis module 22, the average action pattern of the user based on the collected tracking information and stores the result of the analysis in a user action pattern database 52. Also, the invalid click monitoring server 2 compares, using the invalid click determination module 24, the average action pattern with an action the user performs on a website of an advertiser after the user clicks the search advertisement and moves to the website, and determines whether the action performed by the user is an invalid click depending on the comparison. In this instance, the invalid click monitoring server may store determination criteria in an invalid click determination criterion database 54.

More specifically, the tracking information collection module 20 may collect tracking information associated with various types of actions performed by the user that can become criteria to determine the purchase intent of the user. Examples of tracking information about the user action follow:

1) login flag denotes information used to determine whether the user has logged in,

2) referrer denotes a Universal Resource Locator (URL) address of a website that the user previously visited,

3) date time denotes a date and time when a log is received from a log server,

4) userid denotes a unique number of a corresponding tool bar or a hardware serial number of an accessed user computer,

5) windowid denotes an identifier for classifying a plurality of windows that the user opened,

6) click date time denotes a date and time when an actual click occurred,

7) URL denotes a URL address of a website that the user visited,

8) action denotes event information such as focus, unfocus, open, close, and the like. When a plurality of windows is open, it is possible to verify at which URL the user has stayed relatively longer based on focus/unfocus information. Also, it is possible to verify what is a user's front page and at which URL the user has closed a browser based on open/close information.

When providing search and advertisement services abroad, tracking information may further include:

9) country denotes a name of the country that the user accessed when providing services in Japan, the U.S.A., and the like, and

10) GMT denotes Greenwich Mean Time and thus it is possible to verify information regarding where a particular URL is mostly exposed.

The above-described tracking information is collected using the tracking information collection module 20 and is stored in the tracking information database 50.

The user action pattern analysis module 22 analyzes the average action pattern of the user based on the collected tracking information. For example, the user action pattern analysis module 22 observes action patterns or activity patterns (hereinafter referred as to either “action pattern” or “activity pattern”) of users after clicking the search advertisement, analyzes the average action pattern that the users generally take in association with the purchase, and stores the result of the analysis in the user action pattern database 52.

For example, when observing the collected tracking information, action pattern information may be obtained, such as 2-depth travel action where general users with the purchase intent click a search advertisement and subsequently clicks a menu of an advertiser site or accesses a linked site to the advertiser site in order to obtain more information. Specifically, it is possible to accumulate average data about general travel routes of users with the purchase intent and use the accumulated data for various criteria to determine an invalid click.

Conversely, in the case of general users without the purchase intent, abnormal action patterns may be observed, such as directly closing a window of the search advertisement, no click on the window of the search advertisement, copying a telephone number of an advertiser on a screen unassociated with a menu, and the like. The abnormal action patterns also may be used as various criteria to determine the invalid click.

As described above, the conventional methods identify invalid clicks based on a time interval between clicks or based on a number of accesses from the same IP address. Specifically, the conventional methods simply determine invalid clicks using only one criterion. Therefore, it is nearly impossible to cope with various types of invalid clicks that are not connected to the actual purchase. However, according to the present invention, since the average action pattern is analyzed based on tracking information about accumulated user actions and an invalid click is determined based on the result of the analysis, the above problems may be solve. Also, it is possible to acceptably cope with intelligently developing invalid clicks of users.

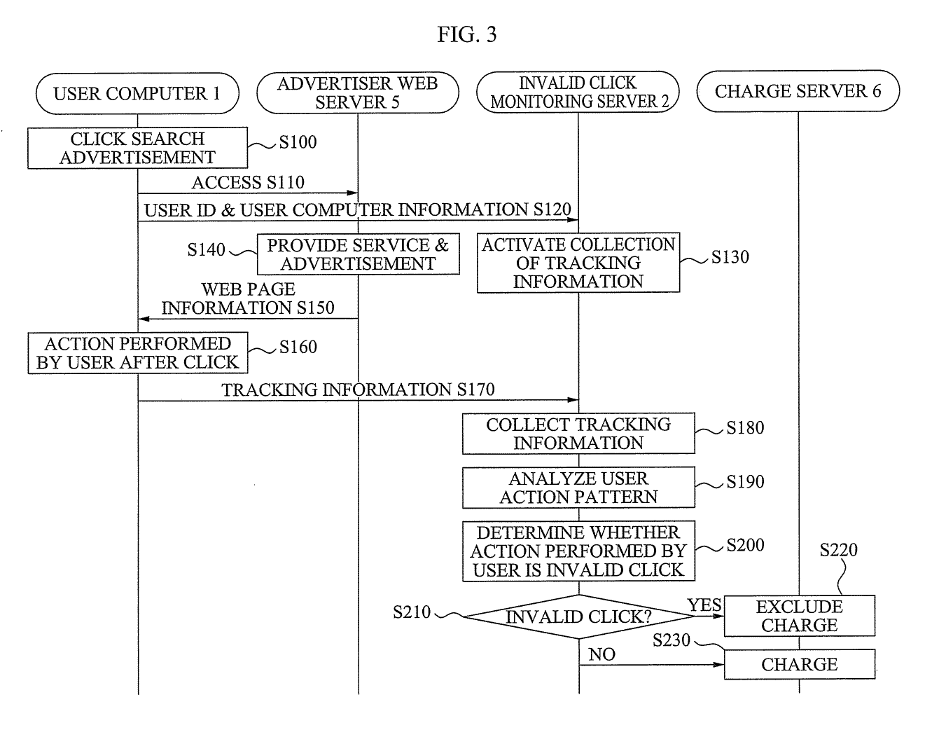

FIG. 3 is a flowchart illustrating a method of monitoring an invalid click according to an exemplary embodiment of the present invention.

Referring to FIG. 3, the method of monitoring the invalid click may include collecting tracking information about an action a user performs on a website of an advertiser after the user clicks the search advertisement and moves to the website, and determining the action performed by the user as the invalid click when the action performed by the user is outside of a predetermined reference value. In an aspect of the present invention, the method may further include analyzing an average action pattern of the user based on the collected tracking information. Also, the method may further include excluding the action performed by the user from a charge when the action performed by the user is determined as the invalid click.

More specifically, when a user at a user computer 1 clicks a search advertisement in operation S100, the user computer 1 accesses a website of an advertiser server 5 in operation S110. The advertiser server 5 displays a corresponding service and advertisement in operations S140 and S150. At the same time, a hardware serial number or a unique number userid of a corresponding tool bar of the accessed user computer 1 is transferred to an invalid click monitoring server 2 in operation S120 to activate collection of tracking information in operation S130. Depending on an action performed by the user after clicking the search advertisement in operation S160, at least one of tracking information is collected in operations S170 and S180. The tracking information includes a login flag, a previously visited URL, a user ID, a window ID, a focus/unfocus/open/close event of a particular window, a currently visited URL, and a date and time when a click on a particular menu occurs. Also, at least one of a country of the accessed user and GMT may be further collected. The invalid click monitoring server 2 analyzes the average action pattern of the user based on the collected tracking information and makes them into a database in operation S190, and determines whether the action performed by the user is an invalid click without the purchase intent based on the result of the analysis in operation S200.

For example, as a result of analyzing collected tracking information, when a user takes a 2-depth travel action, that is, when the user clicks a search advertisement clicks and subsequently clicks a menu of an advertiser site or accesses a linked site to the advertiser site in order to obtain more information, it is possible to determine the user has the purchase intent and determine the action performed by the user as a valid click. Conversely, when abnormal action patterns are observed such as immediately closing a window of the search advertisement, no click on the window of the search advertisement, copying a telephone number of an advertiser on a screen unassociated with a menu, and the like, it is possible to determine the user has no purchase intent and determine the action of the user as the invalid click. However, it is only an example and thus the present invention is not limited thereto. Specifically, it is possible to combine various types of tracking information and thereby create various types of determination criteria for invalid clicks. Also, it is possible to create a more accurate criterion for determining the invalid click by statistically analyzing the tracking information. In the case of the statistical analysis, various conventional arts may be used and thus descriptions related thereto will be omitted herein.

In operation S210, the invalid click monitoring server determines whether the action performed by the user is the invalid click. In the case of the invalid click, a charge server 6 excludes the action from charge in operation S220. Conversely, in the case of a valid click, the charge server 6 charges the advertiser for the action.

The invalid click monitoring method may be readable in a computer program. Codes and code segments that constitute the computer program may be readily understood for computer programmers in the art. Also, the computer program can be stored in computer readable media and read and executed in a computer to embody the invalid click monitoring method. The computer readable media include magnetic media, optical media, and carrier wave media.

As described above, according to the present invention, there is provided a method and apparatus for classifying clicks with the purchase intent based on various types of user actions and thereby effectively monitoring an invalid click.

Also, according to the present invention, it is possible to solve the problems in the conventional art that simply determines invalid clicks using only one criterion such as identifying invalid clicks based on a time interval between clicks or based on a number of accesses from the same IP address, and thus cannot cope with various types of invalid clicks that are not connected to the actual purchase. Also, according to the present invention, since the average action pattern is analyzed based on tracking information about accumulated user actions and an invalid click is determined based on the result of the analysis, the above problems may be solve. Also, it is possible to appropriately cope with intelligently developing invalid clicks of users.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that relative terms are intended to encompass different orientations of the device in addition to the orientation depicted in the Figures.

Moreover, it will be understood that although the terms first, second and third are used herein to describe various features, elements, regions, layers and/or sections, these features, elements, regions, layers and/or sections should not be limited by these terms. These terms are only used to distinguish one feature, element, region, layer or section from another feature, element, region, layer or section. Thus, a first feature, element, region, layer or section discussed below could be termed a second feature, element, region, layer or section, and similarly, a second without departing from the teachings of the present invention.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art.

The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow. The scope of the disclosure is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of monitoring activity associated with a web site, the method comprising:
tracking user's activities after clicking a web site which is displayed as online advertisement, based, at least in part, upon predetermined rules;
collecting said tracking information of user's activities;
analyzing at least one activity pattern of the user's activities based, at least in part, upon said collected tracking information; and
determining if said user's click is an invalid click based, at least in part, upon said analyzed activity pattern and a predetermined reference value.

2. The method of claim 1, wherein said activity pattern being analyzed in accordance with predetermined pattern rules.

3. The method of claim 1, wherein said determined invalid click being not charged for pay per click online advertising.

4. The method of claim 1, wherein the collected tracking information comprises at least one of a login flag, a previously visited Universal Resource Locator (URL), a user identifier (ID), a window ID, a focus/unfocus/open/close event of a particular window, a currently visited URL, and a date and time when a click on a particular menu occurs.

5. The method of claim 4, wherein the collected tracking information further comprises at least one of a country of an accessed user and Greenwich Mean Time (GMT).

6. The method of claim 1, wherein said user's click being determined as an invalid click when said analyzed activity pattern is outside of said predetermined reference value.

7. A storage medium encoded with a machine-readable computer program for implementing a method, the method comprising the steps of:
tracking user's activities after clicking a web site which is displayed as online advertisement, based, at least in part, upon predetermined rules;
collecting said tracking information of user's activities;
analyzing at least one activity pattern of the user's activities based, at least in part, upon said collected tracking information; and
determining if said user's click is an invalid click based, at least in part, upon said analyzed activity pattern and a predetermined reference value.

8. A system for monitoring activity associated with a web site, the system comprising:
a tracking information collection module configured to collect tracking information of user's activities after clicking a web site which is displayed as online advertisement, based, at least in part, upon predetermined rules;
a user action pattern analysis module configured to analyze at least one activity pattern of the user's activities based, at least in part, upon aid collected tracking information; and
an invalid click determination module configured to determine if said user's click is an invalid click based, at least in part, upon said analyzed activity pattern and a predetermined reference value.

9. The system of claim 8, wherein said system is connected to a charge server that excludes the activity performed by the user from a charge, when the activity performed by the user is determined as the invalid click.

10. The system of claim 8, wherein the tracking information collection module collects at least one of a login flag, a previously visited URL, a user ID, a window ID, a focus/unfocus/open/close event of a particular window, a currently visited URL, and a date and time when a click on a particular menu occurs.

11. The system of claim 10, wherein the tracking information collection module further collects at least one of a country of an accessed user and GMT.

12. The system of claim 8, wherein said user's click being determined as an invalid click when said analyzed activity pattern is outside of said predetermined reference value.
